(19) United States
(12) Patent Application Publication
(10) Pub. No.: US 2017/0063568 A1
(43) Pub. Date: Mar. 2, 2017

(54) Method For Controlling Multiple Electric Appliances

(71) Applicant: Grand Mate Co., Ltd, Taichung (TW)

(72) Inventors: Chung-Chin Huang, Taichung (TW); Chin-Ying Huang, Taichung (TW); Hsin-Ming Huang, Taichung (TW); Hsing-Hsiung Huang, Taichung (TW); Yen-Jen Yeh, Taichung (TW)

(73) Assignee: Grand Mate Co., Ltd., Taichung (TW)

(21) Appl. No.: 14/840,662

(22) Filed: Aug. 31, 2015

(51) Int. Cl. H04L 12/28; G09G 5/12; G06F 3/14; G06F 3/0484; G06F 3/0482

(52) U.S. Cl. CPC H04L 12/2825; G06F 3/04842; G06F 3/0482; G06F 3/04847; G06F 3/14; G09G 5/12; H04L 2012/2841

(57) ABSTRACT

A method for wireless control of multiple electric appliances including an electronic device has a screen showing a plurality of first images corresponding to the electric appliances, wherein each of the first images activates showing of a user interface for the corresponding electric appliance on the screen when selected, the method comprising: A. setting a set of connection information in the electronic device, wherein the connection information designates at least one of the electric appliances and actions thereof; B. creating and showing a second image on the screen according to the connection information; and C. selecting the second image, so as to make the electronic device control the designated at least one electric appliance to perform the corresponding actions according to the connection information such that by selecting the second image, multiple electric appliances can be controlled simultaneously.

### BACKGROUND OF THE INVENTION

1. Technical Field

The present invention relates to control of household electric appliances, and more particularly to a method for controlling multiple electric appliances in a wireless way.

2. Description of Related Art

Many electric appliances used in houses are remotely controllable with remote controls, which enable users to operate these electric appliances without physically going to where the appliances are installed. This technology makes our daily life convenient. Presently, there is a wireless control system available in the market. It has a relay device to which a user can connect through an electronic device (e.g., a tablet computer or a smart phone) over a wireless network. The user operates the electronic device to send a control command to the relay device, and then the relay device transmits the received control command wirelessly to a designated electric appliance, so as to make the electric appliance perform a corresponding action. In this manner, the user is enabled to control different electric appliances by operating this single electronic device.

However, in such a conventional wireless control system, it is impossible for a user to use one electronic device to control different electric appliances at the same time. In the event that multiple electric appliances have to be operated, for example when a user wants to turn off multiple electric appliances before leaving his/her house, he/she can only turn off these electric appliances one by one. This process is time-consuming and may delay the time he/she gets off.

### BRIEF SUMMARY OF THE INVENTION

The primary objective of the present invention is to provide a method for controlling multiple electric appliances, which enable a user to simultaneously control multiple electric appliances through a single electronic device.

For achieving the foregoing objective, the method of the present invention is designed to work with a wireless control system. The wireless control system comprises an electronic device that is wirelessly connected to a plurality of electric appliances. The electronic device has a screen that displays a plurality of first images corresponding to the electric appliances, respectively. When selected, e.g., by clicking, the first image activates showing of a user interface for the corresponding electric appliance on the screen. The method comprises the following steps: A. set a set of connection information in the electronic device, wherein the connection information designates at least some of the electric appliances and actions thereof; B. create and render a second image on the screen according to the connection information; and C. click the second image, so as to make the electronic device control the designated electric appliance to perform the corresponding action according to the connection information

The benefit of the present invention is that a user can make the electronic device send the control command to the corresponding electric appliances according to the set connection information by simply selecting, e.g., by clicking, the second image, so as to control the multiple electric appliances to perform corresponding actions.

### BRIEF DESCRIPTION OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a schematic diagram showing a wireless control system according to a preferred embodiment of the present invention;

FIG. 2 is a user interface shown in a touch screen according to the preferred embodiment;

FIG. 3 is a gas fireplace user interface shown on the touch screen according to the preferred embodiment;

FIG. 4 is a flowchart of creating a second image according to the preferred embodiment;

FIG. 5 is a view for selecting an electric appliance on the touch screen according to the preferred embodiment;

FIG. 6 is a view for setting the air conditioner on the touch screen according to the preferred embodiment; and

FIG. 7 is a view of a test page on the touch screen according to the preferred embodiment.

### DETAILED DESCRIPTION OF THE INVENTION

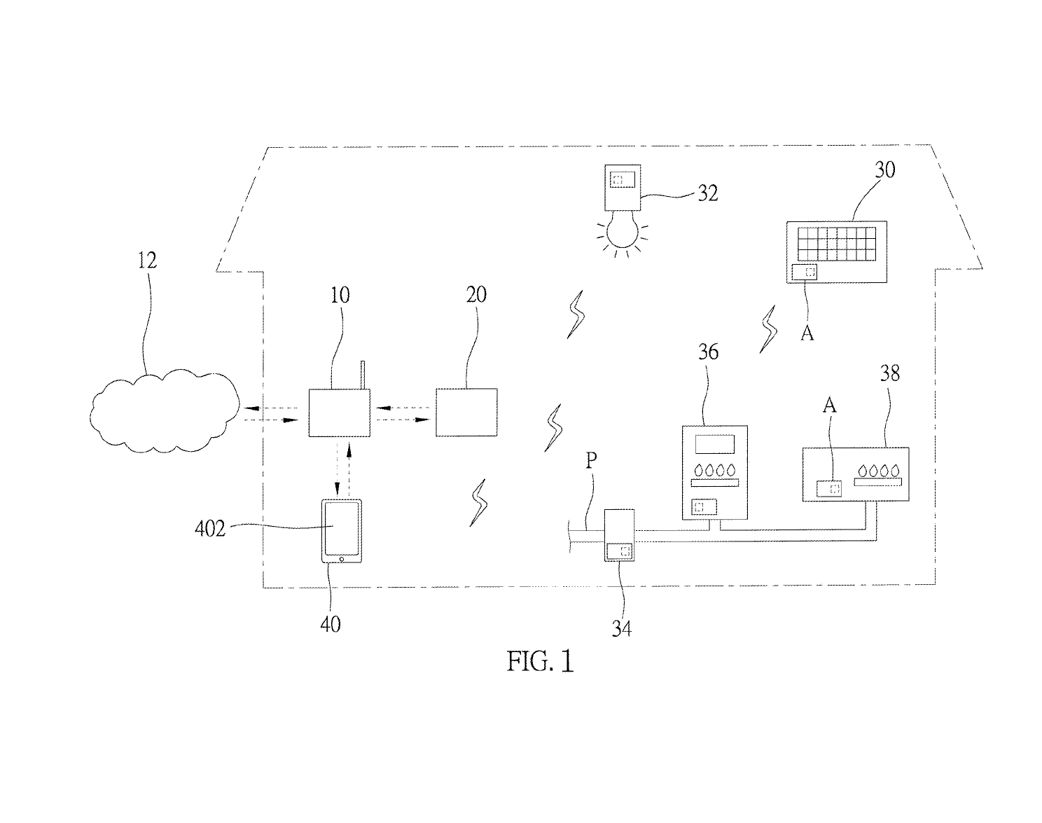

The invention as well as a preferred mode of use, further objectives and advantages thereof will be best understood by reference to the following detailed description of illustrative embodiments when read in conjunction with the accompanying drawings. FIG. 1 schematically depicts a wireless control system working based on the disclosed method according to one preferred embodiment of the present invention. The wireless control system comprises an access point (AP) 10, a signal converting unit 20, a plurality of electric appliances, and an electronic device 40.

The access point 10 is connected to the internet 12 and acts as an intermediary for wireless network connection. The signal converting unit 20 communicates with the access point 10 through wireless, i.e., Wi-Fi signals. The signal converting unit 20 converts a Wi-Fi signal into an radiofrequency (RF) signal and vice versa.

The electric appliances include an air conditioner 30, a light fixture 32, and a plurality of gas appliances. The gas appliances comprise a gas supply valve 34 installed on a gas pipeline P, a gas-fired water heater 36, and a gas fireplace 38. Each of the electric appliances has an RF signal transceiver module A, by which it communicates wirelessly and bi-directionally with the signal converting unit 20 through RF signals.

Each of the electric appliances comprises at least one control option, which is programmed by setting a control parameter, and when selected, the corresponding electric appliance performs a preset action. The electric appliances perform their preset actions when receiving a control command. The control command comprises multiple fields in which different electric appliances, control options and control parameters are designated. Table 1 exemplifies some electric appliances and their corresponding control options, control parameters, as well as corresponding actions. For instance, the gas supply valve 34 has a control option as “On/Off” with its control parameter set as “On” or “Off”. Where the control parameter is set as “On”, the gas supply valve 34 performs the action of opening so as to unblock the gas pipeline. Where the control parameter is set as “Off”, the gas supply valve performs the action of closing so as to block the gas pipeline.

TABLE 1

| Electric | | Control | |
|---|---|---|---|
| Appliances | Control Option | Parameter | Action |
| Air Conditioner | On/Off | On | On-Start to operate |
| | | Off | Off-Stop operating |
| | Temperature | Temperature | Setting indoor |
| | | Value | temperature |
| | Fan Level | Level 1 to 3 | Setting Fan Level, |
| | | | with Level 1 as the |
| | | | minimum, and Level |
| | | | 3 as the maximum |
| Light Fixture | On/Off | On | On-Turning on light |
| | | Off | Off-Turning off light |
| | Illumination | Level 1 to 10 | Adjusting |
| | | | illumination, with |
| | | | Level 1 as the |
| | | | dimmest, and Level |
| | | | 10 as the brightest |
| Gas Supply Valve | On/Off | On | On-Unblocking gas |
| | | Off | pipeline |
| | | | Off-Blocking gas |
| | | | pipeline |
| Gas-Fired Water | Water | Temperature | Setting output water |
| Heater | Temperature | Value | temperature |
| Gas Fireplace | On/Off | On | On-Lighting |
| | | Off | fireplace |
| | | | Off-Extinguishing |
| | | | fireplace |
| | Fire Level | Level 1 to 5 | Adjusting Fire |
| | | | Level, with Level 1 |
| | | | as the minimum, and |
| | | | Level 5 as the |
| | | | maximum |
| | Fan On/Off | on | On-Turning on fan |
| | | off | Off-Turning off fan |
| | Fan Level | Level 1 to 3 | Adjusting Fan Level, |
| | | | with Level 1 as the |
| | | | minimum, and Level |
| | | | 3 as the maximum |
| | Light On/Off | On | On-Turning on light |
| | | Off | Off-Turning off light |
| | Illumination | Level 1 to 3 | Adjusting |
| | | | illumination, with |
| | | | Level 1 as the |
| | | | dimmest, and Level |
| | | | 3 as the brightest |

In the present embodiment, the electronic device 40 is a tablet computer. The electronic device 40 may be directly communicated with the access point 10 through Wi-Fi signals, or connected to the access point 10 through the internet. The electronic device 40 has a screen that in the present embodiment is a touch screen 402. The electronic device 40 runs an application through which a user can operate the electric appliances. The control command set to operate the electric appliances is in the form of a Wi-Fi signal that is transmitted to the signal converting unit 20 through the access point 10. Then the signal converting unit 20 converts the control command into a RF signal that is further transmitted to the corresponding electric appliance(s) to perform control. The control command further comprises a code dedicated to the electronic device 40, so that the electric appliance(s) can identify where the control command comes from. In addition, each of the electric appliances, according to the dedicated code, sends the information about its dedicated appliance code and its operation status in the form of an RF signal to the signal converting unit 20. Then the converting unit 20 converts the information into a Wi-Fi signal that is further transmitted to the electronic device 40, so as for the electronic device 40 having the dedicated code to display and process.

With the configuration described preciously, the method of the present invention for controlling multiple electric appliances can be executed.

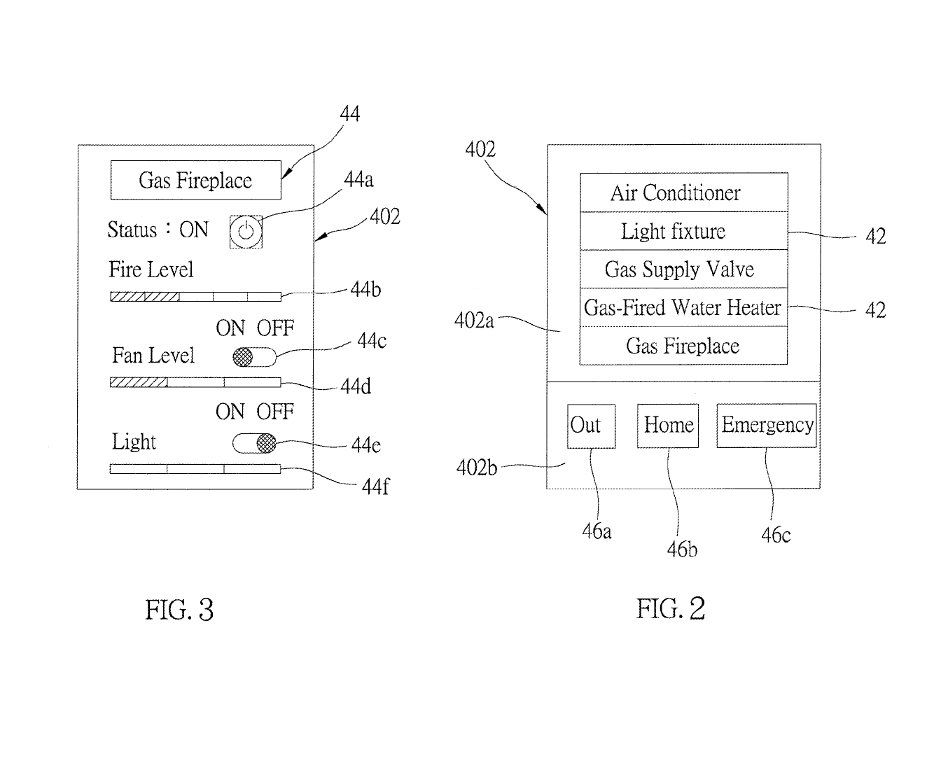

First, the electronic device 40 runs an application. The touch screen 402 shown in FIG. 2 contains a first area 402a and a second area 402b. The first area 402a includes multiple first images 42. The first images 42 each correspond to an electric appliance. Each of the first images 42 can be selected by a user to activate showing of a user interface 44 corresponding to the selected electric appliance in the touch screen 402 (referring to FIG. 3). For example, when the first image 42 corresponding to the gas fireplace 38 is selected, the touch screen 402 renders the user interface 44 for the gas fireplace 38. The user can then use the user interface 44 to select the desired control option. A switch image 44a corresponds to a control option as “On/Off”. A status-bar image 44b corresponds to a control option as “Fire Level”. A switch image 44c corresponds to a control option as “Fan On/Off”. A status-bar image 44d corresponds to a control option as “Fan Level”. A switch image 44e corresponds to a control option as “Light On/Off”. A status-bar image 44f corresponds to a control option as “Illumination”. Moreover, the gas fireplace 38 also feeds the information about its operation back to the electronic device 40, so that the status of On/Off can be displayed in the user interface, and the statuses for Fire Level, Fan Level and Illumination are also shown in the status-bar images 44b, 44d, 44f, respectively.

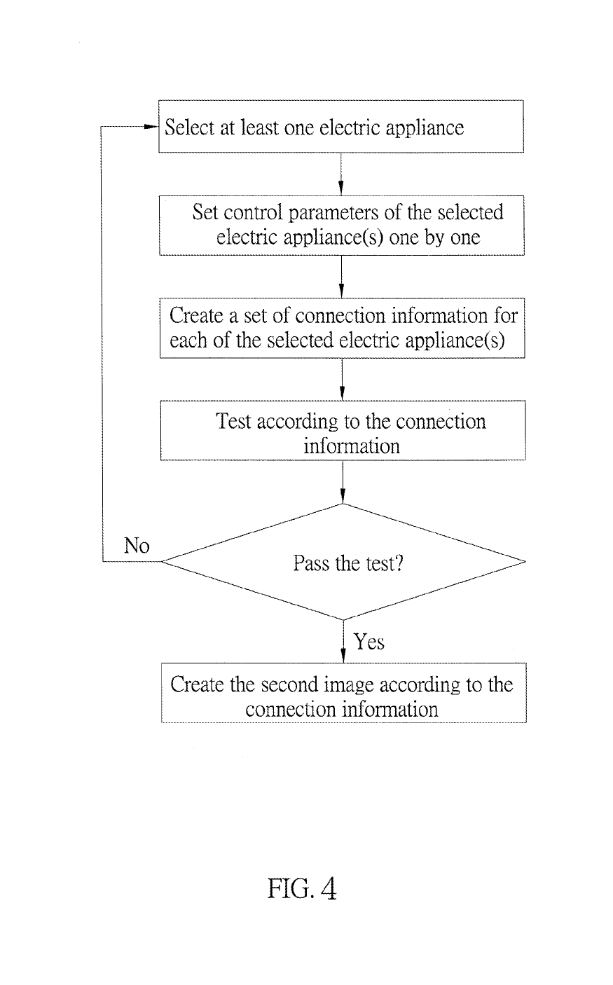

In the second area 402b of the touch screen 402, a plural of second images 46a, 46b, 46c are shown. Each of the second images 46a, 46b, 46c correspondingly controls at least a part of the electric appliances and actions thereof. As how to create the second images 46a, 46b, 46c, please refer to FIG. 4 through FIG. 7 and the following explanation.

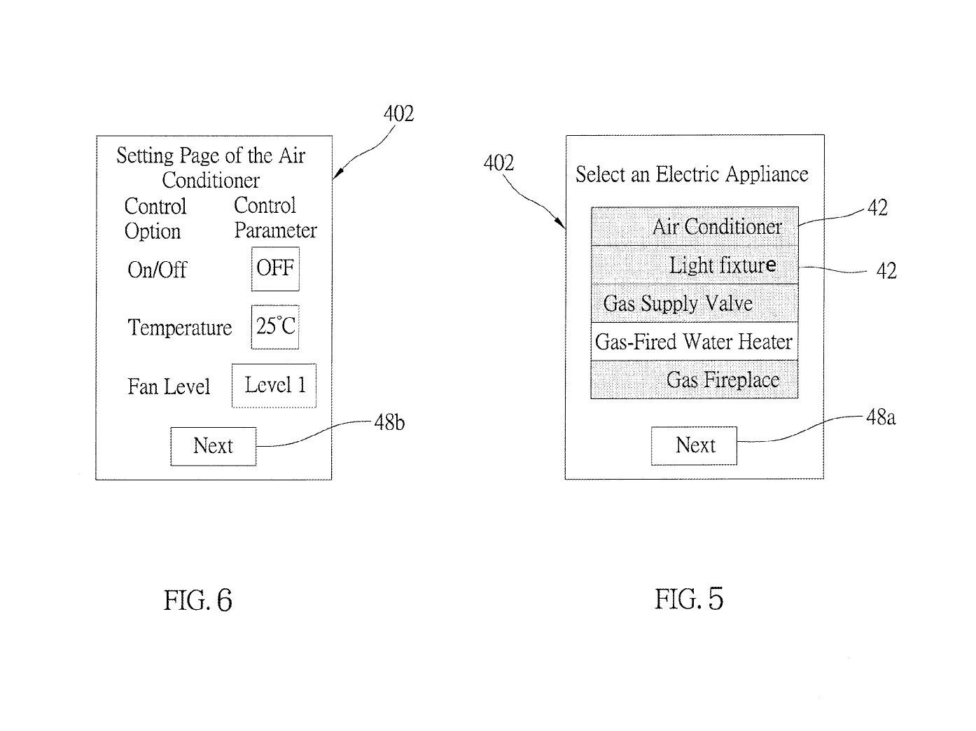

Take the second image 46a which represents “Out” for example, to create the second image 46a, a user can make a long press at any blank space in the second area 402b for several seconds. At this time, all the first images 42 for electric appliances are shown in the touch screen 402 for the user to select (referring to FIG. 5). When the user selects the air conditioner 30, the light fixture 32, the gas supply valve 34, the gas fireplace 38, for example, he/she can press push-button image 48a that is read as “Next”. Then the setting pages for the selected electric appliances will be shown one after one. Referring to FIG. 6, in the setting page for the air conditioner 30, the user can change the control parameters of the control options. When the setting for one control parameter is completed, by pressing the “Next” push-button image 48b, the setting page for the next electric appliance is shown. For example, the On/Off control parameters for the air conditioner 30, the light fixture 32, the gas supply valve 34, and the gas fireplace 38 are all set as off. After all the setting pages for the selected electric appliances are processed, the electronic device 40 uses these settings to create a set of connection information and save it. The connection information is used to designate the selected electric appliances and their actions.

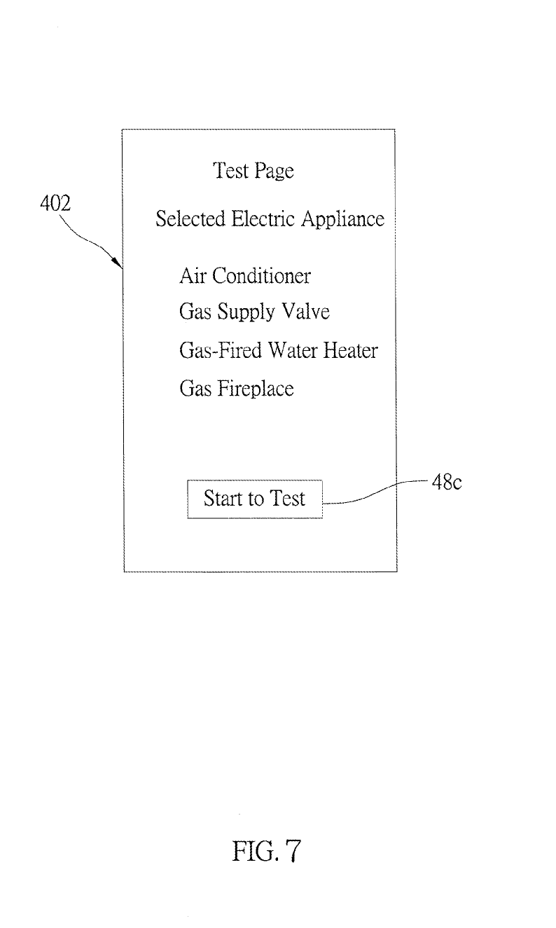

Afterward, a test page is displayed on the touch screen as shown in FIG. 7. Herein, the user can click “Start to Test” push-button image 48c to make the electronic device 40 take a step of test. The testing step according to the connection information sends a corresponding control command to the designated electric appliances (i.e. the air conditioner 30, the light fixture 32, the gas supply valve 34, and the gas fireplace 38), so as to control the designated electric appliances to perform the actions designated in the connection information. Then a dialog box (not shown) is shown to info the user whether the test is successful.

If yes, the user will be asked to name the second image 46a, which is named as “Out” in the current example. Then the second image 46a is created with the name given by the user and the connection information, and is shown in the second area 402b of the second image 46a.

Otherwise, the method goes back to the page for selecting the electric appliances as shown in FIG. 5, for the user to select the electric appliances again and set the control parameters for the electric appliances before the test is performed. In practice, the step of test may be omitted. In such case, the electronic

device 40 directly asks the user to give a name and creates the second images 46a, 46b, 46c according the names given by the user and the connection information.

Where the user needs to create more second images 46b, 46c, the flow shown in FIG. 4 can be repeated by selecting different electric appliances or by selecting different control parameters for the same electric appliance(s), so as to generate different sets of connection information. Then the second images 46b, 46c providing different functions can be created and shown in the second area 402b. Thereby, plural sets of connection information and plural second images 46a, 46b, 46c can be set. In other words, each set of the connection information uniquely designates one or more of the electric appliances and actions thereof that are different from those of another set of connection information.

For example, the second image 46b showing “Home” has its connection information designates the air conditioner 30 and the light fixture 32. The control parameter for the On/Off control option designated for the air conditioner 30 is set as “On”. The control parameter for the temperature control option is set as 25. The control parameter for the fan-level control option is set as Level 1. The control parameter for the On/Off control option designated for the light fixture 32 is set as “On”. The control parameter for the illumination control option is set as Level 5. The second image 46c showing “Emergency” has its connection information designates the light fixture 32 and the gas supply valve 34. The control parameter for the On/Off control option designated for the light fixture 32 is set as “On”. The control parameter for the illumination control option is set as Level 10. The control parameter for the On/Off control option designated for the gas supply valve 34 is set as “Off”.

Then, when one of the second images 46a, 46b, 46c is selected, taking the second image 46a, i.e., “Out”, for example, the electronic device reads the connection information corresponding to the second image 46a, and accordingly sends out the corresponding control commands to the designated electric appliances (i.e. the air conditioner 30, the light fixture 32, the gas supply valve 34, and the gas fireplace 38), so as to make the designated electric appliances perform the designated actions where all of them are turned off.

When the second image 46b, i.e., “Home”, is selected, the control air conditioner 30 and the light fixture 32 are turned on. When the second image 46c, “Emergency”, is selected, the gas supply valve 34 is closed and the light fixture 32 is turned on. Thereby, when encounter an emergency (such as a fire), a user can simply click the second image 46c, i.e., “Emergency”, to stop the supply of gas using the gas supply valve 34, and to have the environment best illuminated by the light fixture 32 for effective evacuation.

Furthermore, when any of the controlled electric appliances receives a control command wirelessly coming from another electronic device (not shown) bearing a different dedicated code that intends to change its action, the controlled electric appliance will send a message to inform the electronic device 40 of this. The message shall comprise the dedicated code of the second electronic device, the appliance code and information about its status, so as to inform the user of the first electronic device 40 that the control of the electric appliance has been taken over by another electronic device. Even if the designated electric appliance is controlled to change its action by a manual operation made on the appliance physically, it is still possible for the appliance to send a message to inform the originally dominating electronic device 40 of this manual operation. In this case, the message shall comprise the appliance code, the information about its status, and a note saying that the operation is a local control. Thereby, a user out of home can be aware of that fact that the electric appliances in his/her house are controlled by another user.

In practice, the method can be alternatively designed as that when a user clicks any of the second images 46a, 46b, 46c, the electronic device 40 sends a control command to the designated electric appliances that comprises a restriction parameter. When receiving the control command, the electric appliances not only perform the corresponding actions, but also refuse the control from another electronic device according to the restriction parameter, until the electronic device 40 sends a control command that comprises a release parameter to the designated electric appliances. Thereby, the electronic device 40 can ensure its exclusive control against the electric appliances designated in its connection information.

With the foregoing scheme, the disclosed method enables a user to click the second image and simultaneously control multiple electric appliances according to the created connection information, so as to eliminate the need of operating the electric appliances one by one and provide effective control.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for controlling multiple electric appliances in a wireless control system, wherein the wireless control system includes an electronic device and the electric appliances that are wirelessly connected; the electronic device has a screen that shows a plurality of first images corresponding to the respective electric appliances; wherein each of the first images activates showing of a user interface for the corresponding electric appliance on the screen when selected; comprising the steps of:
A. setting a set of connection information in the electronic device, wherein the connection information designates at least one of the electric appliances and actions thereof;
B. creating and showing a second image on the screen according to the connection information; and
C. selecting the second image, so as to make the electronic device control the designated at least one electric appliance to perform the corresponding actions according to the connection information.

2. The method of claim 1, wherein the screen comprises a first area and a second area, and the first images are shown in the first area and the second image is shown in the second area.

3. The method of claim 2, further comprising the step of repeating step A and step B at least once, so as to create plural sets of said connection information and plural said second images, wherein the at least one of the electric appliances and actions designated by each set of said connection information are different from those designated by another set of said connection information, wherein step C involves selecting one of the second images, so as to make the electronic device send a control command to the designated at least one electric appliance according to the corresponding connection information.

4. The method of claim 1, further comprising a step of testing between step A and step B, wherein a control command is sent to the designated at least one electric appliance according to the connection information in the step of testing so as to control the designated at least one electric appliance to perform the corresponding actions; after performing the step of testing, a user is informed whether the step of testing is successful; if so, performing step B; if not, returning to step A.

5. The method of claim 1, wherein, after step C, when the designated at least one electric appliance is controlled to change its actions, the controlled at least one electric appliance is operated to send a message to inform the electronic device.

6. The method of claim 5, wherein, while the electronic device is defined as a first electronic device, the wireless control system further comprises a second electronic device that wirelessly controls the electric appliances; when the designated at least one electric appliance is controlled by the second electronic device to change its actions, the electric appliance is operated to send a message to inform the first electronic device, wherein the message comprises a code representing the second electronic device.

7. The method of claim 1, wherein, while the electronic device is defined as a first electronic device, the wireless control system further comprises a second electronic device that wirelessly controls the electric appliances, and the designated at least one electric appliance refuses to be controlled by the second electronic device.

8. The method of claim 1, wherein the electric appliances comprise a gas supply valve and a light fixture; the connection information designates the gas supply valve and the light fixture, and to designate the action of the gas supply valve as closing and the action of the light fixture as turning on; the electronic device closes the gas supply valve and turns on the light fixture in step C.
